(19) United States
(12) Patent Application Publication
(10) Pub. No.: US 2007/0276095 A1
(43) Pub. Date: Nov. 29, 2007

(54) Multistep Process for Preparing Heterophasic Propylene Copolymers

(75) Inventors: Luigi Resconi, Ferrara (IT); Paolo Ferrari, Ferrara (IT); Giuliano Cecchin, Ferrara (IT)

Correspondence Address: BASELL USA INC., INTELLECTUAL PROPERTY, 912 APPLETON ROAD, ELKTON, MD, 21921, US

(73) Assignee: Basell Polyolefine GmbH, Wesseling (DE)

(21) Appl. No.: 10/571,404

(22) PCT Filed: Aug. 4, 2004
(86) PCT No.: PCT/EP04/08759

§ 371 Date: Mar. 10, 2006

Related U.S. Application Data
(60) Provisional application No. 60/503,234, filed on Sep. 16, 2003.

(30) Foreign Application Priority Data
Sep. 11, 2003 (EP) 03102736.0

(51) Int. Cl. C08L 23/04

(52) U.S. Cl. 525/240; 526/160; 526/901; 526/943

(57) ABSTRACT

A multistage process for obtaining an heterophasic propylene polymer comprising the following steps: step a) contacting under polymerization conditions propylene and optionally ethylene or one or more alpha olefins in the presence of a catalysts system, supported on a porous organic polymer, comprising:
ii) one or more metallocene compounds of formula (I) 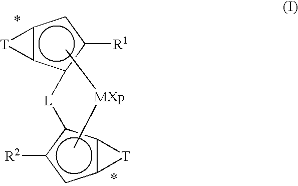 wherein:
M is an atom of a transition metal; p is an integer from 0 to 3; X, same or different, is a hydrogen atom, a halogen atom, or a hydrocarbon group; L is a divalent bridging group; R¹, is a linear or branched, saturated or unsaturated C₁-C₂₀-alkyl radical; R² is a branched C₁-C₂₀alkyl radical;
   T, equal to or different from each other, is a moiety of formula (IIIa) or (IIIb): 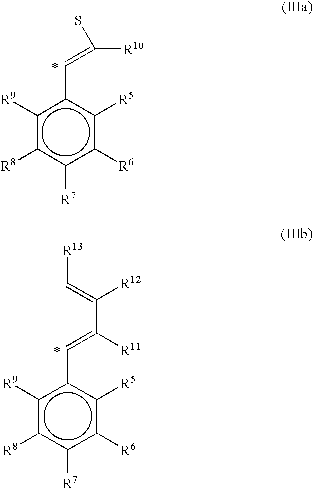 wherein: the atom marked with the symbol * bonds the atom marked with the same symbol in the compound of formula (I);
R⁵-R¹³, equal to or different from each other, are hydrogen atoms or hydrocarbon groups; ii) an alumoxane or a compound capable of forming an alkyl metallocene cation; and optionally iii) an organo aluminium compound; step b) contacting, under polymerization conditions, in a gas phase, ethylene and one or more alpha olefins and optionally a non-conjugated diene, in the presence of the polymer obtained in step a) and optionally in the presence of an additional organo aluminium compound.

The present invention relates to a multistep process for preparing heterophasic propylene copolymers, by using a particular class of metallocene compounds.

Multistep processes for the polymerization of olefins, carried out in two or more reactors, are known from the patent literature and are of particular interest in industrial practice. The possibility of independently varying, in any reactors, process parameters such as temperature, pressure, type and concentration of monomers, concentration of hydrogen or other molecular weight regulator, provides much greater flexibility in controlling the composition and properties of the end product compared to single-step processes. Multistep processes are generally carried out using the same catalyst in the various steps/reactors. The product obtained in one reactor is discharged and sent directly to the next step/reactor without altering the nature of the catalyst.

U.S. Pat. No. 5,854,354 discloses a multistep process in which a propylene polymer is prepared in step a) followed by an ethylene (co)polymer prepared in step b). In the Examples the metallocene-based catalyst system is not supported on a carrier but only prepolymerized. Therefore there is no control on the morphology of the obtained polymer.

U.S. Pat. No. 5,753,773 discloses a multiphase block copolymer of propylene obtained by carrying out the polymerization in different stages without changing the catalyst system by changing the stage. The catalyst system comprises a metallocene compound supported on silica.

WO 01/48034 discloses in some examples a multistep process in which in the first step a propylene polymer is obtained and then, in the second step an ethylene/propylene polymer is produced. In all the examples of this document the metallocene-based catalysts are supported on silica.

A drawback of these processes is that the resulting polymers are often very sticky or in any case they have a poor flowability. Flowability can be measured according to a test reported in the examples that quantifies with a numerical scale (1-8) the tendency of the polymer particles to adhere to each other.

Thus it is desirable to have a process that permits to obtain heterophasic propylene polymer characterized by low values of flowability, so that to avoid fouling in the reactor and improve the processability of the obtained reactor blend.

This problem has been solved by the present invention by carrying out the whole process by using a metallocene-base catalyst system supported on a porous organic polymer.

An object of the present invention is a multistage process comprising the following steps:
a) polymerizing propylene with optionally one or more monomers selected from ethylene and alpha olefins of formula CH₂═CHT¹, wherein T¹ is a C₂-C₂₀ alkyl radical in the presence of a catalysts system, supported on a porous organic polymer, comprising:
i) one or more metallocene compounds of formula (I) 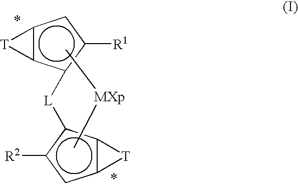
wherein:
M is an atom of a transition metal selected from those belonging to group 3, 4, 5, 6 or to the lanthanide or actinide groups in the Periodic Table of the Elements; preferably M is titanium, zirconium or hafnium;
p is an integer from 0 to 3, preferably p is 2, being equal to the formal oxidation state of the metal M minus 2;
X, same or different, is a hydrogen atom, a halogen atom, or a R, OR, OSO₂CF₃, OCOR, SR, NR₂ or PR₂ group, wherein R is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical, optionally containing heteroatoms belonging to groups 13-17 of the Periodic Table of the Elements; or two X can optionally form a substituted or unsubstituted butadienyl radical or a OR′O group wherein R is a divalent radical selected from C₁-C₂₀ alkylidene, C₆-C₄₀ arylidene, C₇-C₄₀ alkylarylidene and C₇-C₄₀ arylalkylidene radicals; preferably X is a hydrogen atom, a halogen atom or a R group;
more preferably X is chlorine or a methyl radical;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms such as SiMe₂, SiPh₂; preferably L is selected from the group consisting of is Si(CH₃)₂, SiPh₂, SiPhMe, SiMe(SiMe₃), CH₂, (CH₂)₂, (CH₂)₃ and C(CH₃)₂;
R¹, is a linear or branched, saturated or unsaturated C₁-C₄₀-alkyl radical, optionally containing one or more heteroatoms belonging to groups 13-17 of the Periodic Table of the Elements; preferably R¹ is a methyl or ethyl radical;
R² is a branched C₁-C₄₀-alkyl radical; preferably R² is a group of formula (II) 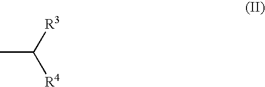
wherein R³ and R⁴, equal to or different from each other, are linear or branched, saturated or unsaturated C₁-C₁₀-alkyl radicals optionally containing one or more heteroatoms belonging to groups 13-17 of the Periodic Table of the Elements;
T, equal to or different from each other, is a moiety of formula (IIIa) or (IIIb): 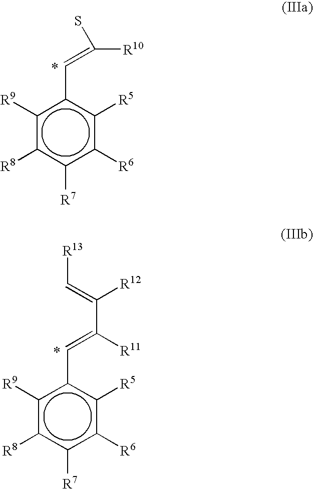
wherein:
the atom marked with the symbol * is bonded to the atom marked with the same symbol in the compound of formula (I);
R⁵, R⁶, R⁷, R⁸ and R⁹, equal to or different from each other, are hydrogen atoms or a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or two or more R⁵, R⁶, R⁷, R⁸ and R⁹ can join to form a 4-7 saturated or unsaturated membered rings, said ring can bear C₁-C₂₀ alkyl substituents;
R¹⁰ is a hydrogen atom or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; preferably R¹⁰ is a hydrogen atom or a linear or branched, saturated C₁-C₂₀-alkyl radical, such as a methyl, ethyl or isopropyl radical;
R¹¹, R¹² and R¹³, equal to or different from each other, are hydrogen atoms or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two or more R¹¹, R¹² and R¹³ can join to form a 4-7 saturated or unsaturated membered rings, said ring can bear C₁-C₂₀ alkyl substituents;
ii) an alumoxane or a compound capable of forming an alkyl metallocene cation; and optionally
iii) an organo aluminum compound;
b) contacting, under polymerization conditions, in a gas phase, ethylene with one or more alpha olefins of formula CH₂═CHT², wherein T² is a C₁-C₂₀ alkyl radical, and optionally with a non-conjugated diene, in the presence of the polymer obtained in step a) and optionally in the presence of an additional organo aluminum compound.

The compound of formula (1) is preferably in the racemic or racemic-like form. “Racemic-like” means that the benzo or thiophene moieties of the two n-ligands on the metallocene compound of formula (I) are on the opposite sides with respect to the plane containing the zirconium and the centre of the cyclopentadienyl moieties as shown in the following compound.

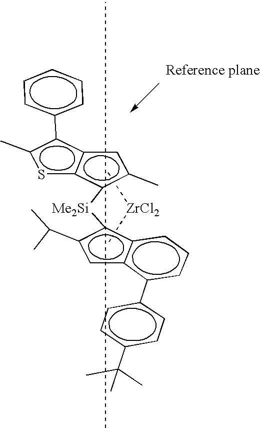

One preferred class of compounds of formula (I) is that wherein R⁵, R⁶ R⁸ and R⁹, are hydrogen atoms and R⁷ is a group of formula —C(R¹⁴)₃ wherein R¹⁴, equal to or different from each other, are a linear or branched, saturated or unsaturated C₁-C₁₀-alkyl, C₃-C₁₀-cycloalkyl, C₆-C₁₀-aryl, C₇-C₁₀-alkylaryl, or C₇-C₁₀-arylalkyl radicals, optionally containing one or more heteroatoms belonging to groups 13-17 of the Periodic Table of the Elements; preferably R¹⁴ are linear C₁-C₁₀-alkyl radicals; more preferably they are methyl, or ethyl radicals.

A further preferred class of compounds of formula (I) is that wherein both T groups have formula (IIIb) and R⁵, R⁶, R⁷, R⁸ and R⁹ have the meaning described above. Preferably in one T group, R¹² is a C₁-C₂₀ alkyl radical; preferably a C₁-C₁₀ alkyl radical; more preferably a methyl or ethyl group and in the other T group R¹² being hydrogen.

A further preferred class of compounds of formula (1) is that wherein one T group has formula (IIIa) and the other one has formula (IIIb) and R⁵, R⁶, R⁷, R⁸ and R⁹ have the meaning described above.

A still further preferred class of compounds of formula (I) is that wherein both T groups have formula (IIIb), R⁵, R⁶, R⁷, R⁸ and R⁹ have the meaning described above and R¹¹, R¹² and R¹³ are hydrogen atoms

Compounds of formula (I) are known in the art, for example they can be prepared according to the disclosure of WO 01/48034, PCT/EP02/13552 and DE 10324541.3

The porous polymer supports that can be used for the process of the present invention are porous polymers such as styrene/divinylbenzene copolymers, polyamides, or porous alpha-olefin polymers.

Preferably porous alpha-olefin polymers are used, such as polyethylene, polypropylene, polybutene, copolymers of propylene and copolymers of ethylene.

Two particularly suitable classes of porous alpha-olefin polymers are those obtained according to WO 01/46272 and WO 02/051887 particularly good results are obtained when the catalyst described WO 01/46272 is used with the process described in WO 02/051887. Polymers obtained according to WO 01/46272 have a high content of the so-called stereoblocks, i.e. of polymer fractions which, although predominantly isotactic, contain a not negligible amount of non-isotactic sequences of propylene units. In the conventional fractionation techniques such as the TREF (Temperature Rising Elution Temperature) those fractions are eluted at temperatures lower than those necessary for the more isotactic fractions. The polymers obtained according to the process described in WO 02/051887 show improved porosity.

The organic porous polymer has preferably porosity due to pores with diameter up 10 μm (100000 Å) measured to the method reported below, higher than 0.1 cc/g preferably comprised between 0.2 cc/g to 2 cc/g; more preferably from 0.3 cc/g to 1 cc/g.

Preferably in the organic porous polymer fit as support according to the process of the present invention, the total porosity due to all pores whose diameter is comprised between 0.1 μm (1000 Å) and 2 μm (20000 Å) is at least 30% of the total porosity due to all pores whose diameter is comprised between 0.02 μm (200 Å) and 10 μm (100000 Å). Preferably the total porosity due to all pores whose diameter is comprised between 0.1 μm (1000 Å) and 2 μm (20000 Å) is at least 40% of the total porosity due to all pores whose diameter is comprised between 0.02 μm (200 Å) and 10 μm (100000 Å). More preferably the total porosity due all pores whose diameter is comprised between 0.1 μm (1000 Å) and 2 μm (20000 Å) is at least 50% of the total porosity due all pores whose diameter is comprised between 0.02 μm (200 Å) and 10 μm (100000 Å).

The catalyst system supported on a porous organic polymer support used in the process of the present invention, can be obtained depositing the metallocene compound i) or the product of the reaction thereof with the component ii), or the component ii) and then the metallocene compound i) on the porous polymer support. The supportation process is carried out in an inert solvent such as hydrocarbon for example toluene, hexane, pentane or propane and at a temperature ranging from 0° C. to 100° C., preferably the process is carried out at a temperature ranging from 25° C. to 90° C. A preferred supportation process is described in WO 01/44319.

A particularly suitable process for supporting the catalyst system is described in W001/44319, wherein the process comprises the steps of:
(a) preparing a catalyst solution comprising a catalyst system;
(b) introducing into a contacting vessel:
(i) a porous support material in particle form, and
(ii) a volume of the catalyst solution not greater than the total pore volume of the porous support material introduced;
(c) discharging the material resulting from step (b) from the contacting vessel and suspending it in an inert gas flow, under such conditions that the solvent evaporates; and
(d) reintroducing at least part of the material resulting from step (c) into the contacting vessel together with another volume of the catalyst solution not greater than the total pore volume of the reintroduced material.

Alumoxanes used as component ii) can be obtained by reacting water with an organo-aluminium compound of formula HⱼAlU₃₋ⱼ or HⱼAl₂U₆₋ⱼ, where U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or or C₇-C₂₀-arylalkyl radical, optionally containing silicon or germanium atoms with the proviso that at least one U is different from halogen, and j ranges from 0 to 1, being also a non-integer number. In this reaction the molar ratio of Al/water is preferably comprised between 1:1 and 100:1. The molar ratio between aluminium and the metal of the metallocene generally is comprised between about 10:1 and about 20000:1, and more preferably between about 100:1 and about 5000:1.

The alumoxanes used in the catalyst according to the invention are considered to be linear, branched or cyclic compounds containing at least one group of the type: 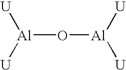
wherein the substituents U, same or different, are defined above.

In particular, alumoxanes of the formula: 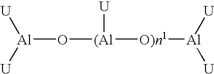
can be used in the case of linear compounds, wherein n¹ is 0 or an integer of from 1 to 40 and the substituents U are defined as above; or alumoxanes of the formula: 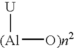
can be used in the case of cyclic compounds, wherein n²is an integer from 2 to 40 and the U substituents are defined as above.

Examples of alumoxanes suitable for use according to the present invention are methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO) and tetra-(2,3,3-trimethylbutyl)alumoxane (TTMBAO).

Particularly interesting cocatalysts are those described in WO 99/21899 and in WO01/21674 in which the alkyl and aryl groups have specific branched patterns.

Non-limiting examples of aluminium compounds that can be reacted with water to give suitable alumoxanes (b), described in WO 99/21899 and WO01/21674, are: tris(2,3,3-trimethyl-butyl)aluminium, tris(2,3-dimethyl-hexyl)aluminium, tris(2,3-dimethyl-butyl)aluminium, tris(2,3-dimethyl-pentyl)aluminium, tris(2,3-dimethyl-heptyl)aluminium, tris(2-methyl-3-ethyl-pentyl)aluminium, tris(2-methyl-3-ethyl-hexyl)aluminium, tris(2-methyl-3-ethyl-heptyl)aluminium, tris(2-methyl-3-propyl-hexyl)aluminium, tris(2-ethyl-3-methyl-butyl)aluminium, tris(2-ethyl-3-methyl-pentyl)aluminium, tris(2,3-diethyl-pentyl)aluminium, tris(2-propyl-3-methyl-butyl)aluminium, tris(2-isopropyl-3-methyl-butyl)aluminium, tris(2-isobutyl-3-methyl-pentyl)aluminium, tris(2,3,3-trimethyl-pentyl)aluminium, tris(2,3,3-trimethyl-hexyl)aluminium, tris(2-ethyl-3,3-methyl-butyl)aluminium, tris(2-ethyl-3,3-dimethyl-pentyl)aluminium, tris(2-isopropyl-3,3-dimethyl-butyl)aluminium, tris(2-trimethylsilyl-propyl)aluminium, tris(2-methyl-3-phenyl-butyl)aluminium, tris(2-ethyl-3-phenyl-butyl)aluminium, tris(2,3-dimethyl-3-phenyl-butyl)aluminium, tris(2-phenyl-propyl)aluminium, tris[2-(4-fluoro-phenyl)-propyl]aluminium, tris[2-(4-chloro-phenyl)-propyl]aluminium, tris[2-(3-isopropyl-phenyl)-propyl]aluminium, tris(2-phenyl-butyl)aluminium, tris(3-methyl-2-phenyl-butyl)aluminium, tris(2-phenyl-pentyl)aluminium, tris[2-(pentafluorophenyl)-propyl]aluminium, tris[2,2-diphenyl-ethyl]aluminium and tris[2-phenyl-2-methyl-propyl]aluminium, as well as the corresponding compounds wherein one of the hydrocarbyl groups is replaced with a hydrogen atom, and those wherein one or two of the hydrocarbyl groups are replaced with an isobutyl group.

Amongst the above aluminium compounds, trimethylaluminium (TMA), triisobutylaluminium (TIBA), tris(2,4,4-trimethyl-pentyl)aluminium (TIOA), tris(2,3-dimethylbutyl)aluminium (TDMBA) and tris(2,3,3-trimethylbutyl)aluminium (TTMBA) are preferred.

Non-limiting examples of compounds able to form an alkylmetallocene cation are compounds of formula D⁺E⁻, wherein D⁺ is a Brøonsted acid, able to donate a proton and to react irreversibly with a substituent X of the metallocene of formula (I) and E is a compatible anion, which is able to stabilize the active catalytic species originating from the reaction of the two compounds, and which is sufficiently labile to be removed by an olefinic monomer. Preferably, the anion E comprises one or more boron atoms. More preferably, the anion F is an anion of the formula BAr₄⁽⁻⁾, wherein the substituents Ar which can be identical or different are aryl radicals such as phenyl, pentafluorophenyl or bis(trifluoromethyl)phenyl. Tetrakis-pentafluorophenyl borate is particularly preferred compound, as described in WO 91/02012. Moreover, compounds of formula BAr₃ can be conveniently used. Compounds of this type are described, for example, in the International patent application WO 92/00333. Other examples of compounds able to form an alkylmetallocene cation are compounds of formula BAr₃P wherein P is a substituted or unsubstituted pyrrol radical. These compounds are described in WO01/62764. Compounds containing boron atoms can be conveniently supported according to the description of DE-A-19962814 and DE-A-19962910. All these compounds containing boron atoms can be used in a molar ratio between boron and the metal of the metallocene comprised between about 1:1 and about 10:1; preferably 1:1 and 2.1; more preferably about 1:1.

Non limiting examples of compounds of formula D⁺E⁻ are:
Triethylammoniumtetra(phenyl)borate,
Tributylammoniumtetra(phenyl)borate,
Trimethylammoniumtetra(tolyl)borate,
Tributylammoniumtetra(tolyl)borate,
Tributylammoniumtetra(pentafluorophenyl)borate,
Tributylarmoniumtetra(pentafluorophenyl)aluminate,
Tripropylammoniumtetra(dimethylphenyl)borate,
Tributylammoniumtetra(trifluoromethylphenyl)borate,
Tributylammoniumtetra(4-fluorophenyl)borate,
N,N-Dimethylbenzylammonium-tetrakispentafluorophenylborate,
N,N-Dimethylhexylamonium-tetrakispentafluorophenylborate,
N,N-Dimethylaniliniumtetra(phenyl)borate,
N,N-Diethylaniliniumtetra(phenyl)borate,
N,N-Dimethylaniliniumtetrakis(pentafluorophenyl)borate,
N,N-Dimethylaniliniumtetrakis(pentafluorophenyl)aluminate,
N,N-Dimethylbenzylammonium-tetrakispentafluorophenylborate,
N,N-Dimethylhexylamonium-tetrakispentafluorophenylborate,
Di(propyl)ammoniumtetrakis(pentafluorophenyl)borate,
Di(cyclohexyl)ammoniumtetrakis(pentafluorophenyl)borate,
Triphenylphosphoniumtetrakis(phenyl)borate,
Triethylphosphoniumtetrakis(phenyl)borate,
Diphenylphosphoniumtetrakis(phenyl)borate,
Tri(methylphenyl)phosphoniumtetrakis(phenyl)borate,
Tri(dimethylphenyl)phosphoniumtetrakis(phenyl)borate,
Triphenylcarbeniumtetrakis(pentafluorophenyl)borate,
Triphenylcarbeniumtetrakis(pentafluorophenyl)aluminate,
Triphenylcarbeniumtetrakis(phenyl)aluminate,
Ferroceniumtetrakis(pentafluorophenyl)borate,
Ferroceniumtetrakis(pentafluorophenyl)aluminate.
Triphenylcarbeniumtetrakis(pentafluorophenyl)borate, and
N,N-Dimethylaniliniumtetrakis(pentafluorophenyl)borate.

Organic aluminum compounds used as compound iii) are those of formula HⱼAlU₃₋ⱼ or HⱼAl₂U₆₋ⱼ as described above.

Preferably step a) further comprises a prepolymerization step a-1).

The prepolymerization step a-1) can be carried out by contacting the catalyst system supported on the porous organic support with one ore more alpha olefins of formula CH²═CHT³ wherein T³ is hydrogen or a C₁-C₂₀ alkyl radical; preferably said alpha olefin is propylene or ethylene, at a temperature ranging from −20° C. to 70° C., in order to obtain a prepolymerized catalyst system containing preferably from 5 to 500 g of polymer per gram of catalyst system.

Thus preferably step a) comprises

a-1) contacting the catalyst system described above with ethylene and/or propylene and/or one ore more alpha olefins of formula CH₂═CHT¹, wherein T¹ is a C₂-C₂₀ alkyl radical; preferably propylene or ethylene in order to obtain a prepolymerized catalyst system preferably containing from 5 to 500 g of polymer per gram of catalyst system;
a-2) polymerizing propylene and optionally one or more monomers selected from ethylene and alpha olefins of formula CH₂═CHT¹, wherein T¹ is a C₂-C₂₀ alkyl radical in the presence of the prepolymerized catalyst system obtained in step a-1).

Step a) of the present invention can be carried out in liquid phase, in which the polymerization medium can be an inert hydrocarbon solvent or the polymerization medium can be liquid propylene optionally in the presence of an inert hydrocarbon solvent, and of one or more comonomer of formula CH₂═CHT¹, or step a) can be carried out in a gas phase. Said hydrocarbon solvent can be either aromatic (such as toluene) or aliphatic (such as propane, hexane, heptane, isobutane, cyclohexane and 2,2,4-trimethylpentane).

Preferably the polymerization medium is liquid propylene. It can optionally contains minor amounts (up to 20% by weight, preferably up to 10% by weight, more preferably up to 5% by weight) of an inert hydrocarbon solvent or of one or more comonomer of formula CH₂═CHT¹.

Step a) can be carried out in the presence of hydrogen. The amount of hydrogen present during the polymerization reaction is preferably more than 1 ppm; more preferably from 5 to 2000 ppm; even more preferably from 6 to 500 ppm with respect to the propylene present in the reactor. Hydrogen can be added either at the beginning of the polymerization reaction or it can also be added at a later stage after a prepolymerization step has been carried out.

The propylene polymer obtained in step a) is a propylene homopolymer or a propylene copolymer containing up to 20% by mol preferably from 0.1 to 10% by mol, more preferably from 1% to 5% by mol of derived units of one or more alpha olefins of formula CH₂═CHT¹. Non-limiting examples of alpha olefins of formula CH₂═CHT¹ which can be used in the process of the invention are ethylene, 1-butene, 1-pentene, 4-methyl-1 -pentene, 1-hexene, 1-octene, 4,6-dimethyl-1-heptene, 1-decene, 1-dodecene, 1-tetradecene, 1-hexadecene, 1-octadecene and 1-eicosene. Preferred comonomers are ethylene or 1-butene. Preferably in step a) a propylene homopolymer is produced.

The content of the polymer obtained in step a) ranges from 5% to 90% by weight of the polymer produced in the whole process, preferably it ranges from 10% to 70% by weight more preferably from 15% to 50% by weight of the total polymer produced in the whole process.

Step b) is carried out in a gas phase, preferably in a fluidized bed reactor. The polymerization temperature is generally comprised between −100° C. and +200° C., and, preferably, between 10° C. and +90° C. The polymerization pressure is generally comprised between 0.5 and 100 bar.

In step b) an ethylene copolymer containing from 5% to 90% by mol, preferably from 10% to 50% by mol, more preferably from 15% to 30% by mol of derived units of one or more alpha olefins of formula CH₂═CHT² is produced. Examples of comonomer of formula CH₂═CHT² that can be used in step b) of the present invention are: propylene, 1-butene, 1-pentene, 4-methyl-1-pentene, 1-hexene, 1-octene, 4,6-dimethyl-1-heptene, 1-decene, 1-dodecene, 1-tetradecene, 1-hexadecene, 1-octadecene and 1-eicosene. Preferred comonomers are propylene or 1-butene.

The content of polymer obtained in step b) preferably ranges from 10 to 95% by weight of the polymer produced in the whole process, preferably it ranges from 30% to 90% by weight and more preferably from 50% to 85% by weight.

The polymer obtained in step b) can optionally contains up to 20% by mol of a non conjugated diene. Non conjugated dienes can be a straight chain, branched chain or cyclic hydrocarbon diene having from 6 to 20 carbon atoms. Examples of suitable non-conjugated dienes are:
straight chain acyclic dienes, such as 1,4-hexadiene and 1,6-octadiene;
branched chain acyclic dienes, such as 5-methyl-1,4-hexadiene, 3,7-dimethyl-1,6-octadiene, 3,7-dimethyl-1,7-octadiene and mixed isomers of dihydro myricene and dihydroocinene;
single ring alicyclic dienes, such as 1,3-cyclopentadiene, 1,4-cyclohexadiene, 1,5-cyclooctadiene and 1,5-cyclododecadiene;
multi-ring alicyclic fused and bridged ring dienes, such as tetrahydroindene, methyl tetrahydroindene, dicyclopentadiene, bicyclo-(2,2,1)-hepta-2,5-diene; and
alkenyl, alkylidene, cycloalkenyl and cycloalkylidene norbornenes, such as 5-methylene-2-norbornene (MNB), 5-propenyl-2-norbornene, 5-isopropylidene-2-norbornene,5-(4-cyclopentenyl)-2-norbornene, 5-cyclohexylidene-2-norbornene, 5-vinyl-2-norbornene and norbomadiene.

Preferred dienes are 1,4-hexadiene (HD), 5-ethylidene-2-norbornene (ENB), 5-vinylidene-2-norbornene (VNB), 5-methylene-2-norbornene (MNB) and dicyclopentadiene (DCPD). Particularly preferred dienes are 5-ethylidene-2-norbornene (ENB) and 1,4-hexadiene (HD).

When present the non-conjugated dienes are preferably incorporated into the polymer in an amount from 0.1% to about 20% by mol, preferably from 0.5% to 15% by mol, and more preferably from 0.5% to 7% by mol. If desired, more than one diene may be incorporated simultaneously, for example HD and ENB, with total diene incorporation within the limits specified above.

The process of the present invention can be carried out in one reactor or in two or more reactor in series.

In particular with the process of the present application heterophasic propylene polymers having excellent flowability and in high yields can be obtained. Flowability can be measured according to the procedure reported below. This test gives a numeric value that measures the flowability index of the polymer.

Thus a further object of the present invention is a propylene polymer compositions obtainable according to the process of the present invention comprising:
a) 5% to 90% by weight, preferably from 10% to 70% by weight, more preferably from 15% to 50% by weight of a propylene homopolymer or a propylene copolymer containing up to 20% by mol preferably from 0.1 to 10% by mol, more preferably from 1% to 5% by mol of derived units of one or more alpha olefins of formula CH₂═CHT¹;

said propylene polymer or copolymer having isotactic pentads (mmmm) higher than 90%, preferably higher than 95% more preferably higher than 97%;
b) from 10 to 95% by weight preferably from 30% to 90% by weight and more preferably from 50% to 85% by weight of an ethylene copolymer containing from 5% to 90% by mol, preferably from 10% to 50% by mol, more preferably from 15% to 30% by mol, of derived units of one or more alpha olefins of formula CH₂═CHT²;
   said composition having a flowability index equal to or lower than 2.

Preferably compound a) has a distribution of molecular weight Mw/Mn lower than 4; preferably lower than 3; more preferably lower than 2.5.

Preferably compound b) has a distribution of molecular weight Mw/Mn lower than 4; preferably lower than 3; more preferably lower than 2.5.

The ethylene copolymer b) can further optionally contains up to 20% by mol of derived units of a non conjugated diene, preferably in an amount from 0.1% to about 20% by mol; more preferably from 0.5% to 15% by mol, and still more preferably from 0.5% to 7% by mol.

Preferred monomers to be copolymerized with ethylene in step b) are propylene and 1-butene.

The following examples are given to illustrate and not to limit the invention.

### EXAMPLES

General Characterization

Determination of X.S.

2.5 g of polymer were dissolved in 250 ml of o-xylene under stirring at 135° C. for 30 minutes, then the solution was cooled to 25° C. and after 30 minutes the insoluble polymer was filtered. The resulting solution was evaporated in nitrogen flow and the residue was dried and weighed to determine the percentage of soluble polymer (XS) and then, by difference, the insolubles (X.I.).

NMR

The proton and carbon spectra of polymers were obtained using a Bruker DPX 400 spectrometer operating in the Fourier transform mode at 120° C. at 400.13 MHz and 100.61 MHz respectively. The samples were dissolved in C₂D₂Cl₄. As reference the residual peak of C₂DHCl₄ in the ¹H spectra (5.95 ppm) and the peak of the mmmm pentad in the ¹³C spectra (21.8 ppm) were used. Proton spectra were acquired with a 45° pulse and 5 seconds of delay between pulses; 256 transients were stored for each spectrum. The carbon spectra were acquired with a 90° pulse and 12 seconds (15 seconds for ethylene based polymers) of delay between pulses and CPD (waltz 16) to remove ¹H-¹³C couplings. About 3000 transients were stored for each spectrum.

The intrinsic viscosity (I.V.) was measured in tetrahydronaphtalene (THN) at 135° C.

Metallocene Compounds

rac-dimethylsilanediyl(2-methyl-4-(4′-tert-butylphenyl)indenyl)(2-isopropyl-4-(4′-tetr-butylphenyl)indenyl)zirconium dichloride (A-1) was prepared according to the procedure described in WO 01/48034

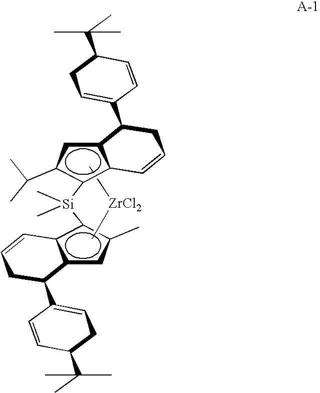

rac-dimethylsilanediyl(2,6-dimethyl-4-(4′-tert-butylphenyl)indenyl)(2-isopropyl-4-(4′-tetr-butylphenyl)indenyl)zirconium dichloride (A-2) ) was prepared according to the procedure described in DE 10324541.3

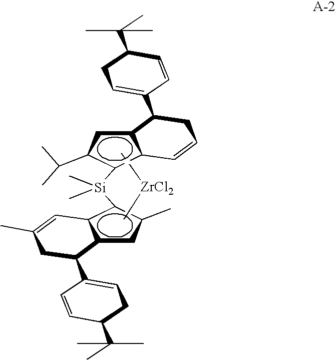

{Me₂Si (4-(4-tert-Butyl-phenyl)-2-isopropyl-inden-1-yl)(2,5-dimethyl-3-phenyl-cyclopento[2,3-b]thiophen-6-yl)}ZrCl₂ (A-3) was prepared according to the procedure described in PCT/EP02/13552

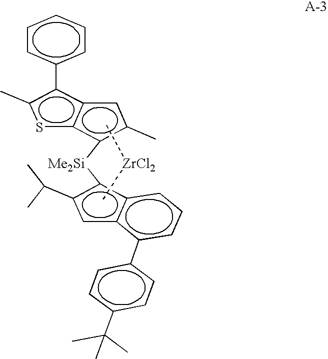

{Me₂Si (4-(4-tert-Butyl-phenyl)-2-isopropyl-inden-1-yl)(2,5-dimethyl-3-(4-tert-butyl-phenyl)-cyclopento[2,3-b]thiophen-6-yl)}ZrCl₂. (A-4) was prepared according to the procedure described in PCT/EP02/13552.

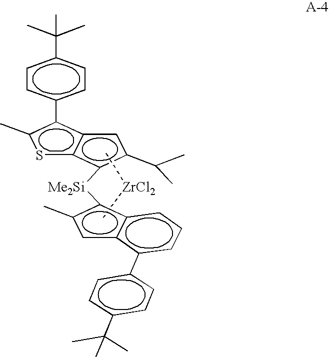

Porous Organic Polymer Supports

Polypropylene prepolymer (support A) was produced according to the procedure described in the example I of WO 00/08065, under the following conditions: polymerisation temperature 20° C., AliBu₃ (AliBu₃/ZN catalyst=1 (w/w)), propylene flow=1 kg/h for 2 h, then 5 kg/h for 6 h (conversion 40 g_{PP}/g_{cat}). Characterization data of the polymer are reported in table 1

Polyethylene prepolymer (support B) was produced according to the procedure described in example 1 of WO 95/26369, under the following conditions: polymerisation temperature 0° C., AliBu₃ (AliBu₃/ZN catalyst=1 (w/w)), 1.5 bar-g of ethylene (conversion of 40 g_{PE}/g_{cat}). Characterization data of the polymer are reported in table 1

TABLE 1

| | | % of pores having diameter | |
|---|---|---|---|
| | | comprised between 0.1 μm | |
| Support | PBD g/ml | (1000 Å) and 2 μm (20000 Å) | Porosity cc/g |
| A | 0.262 | 69.93 | 0.585 |
| B | 0.626 | 64.51 | 0.663 |

Preparation of the Catalyst Systems

Catalyst C-1

4.6 g of support B described above, were treated with H₂O dispersed in hexane in order to deactivate the MgCl₂/Ti-based catalyst, then dried in a flow of nitrogen. The support is contacted with 0.5mL of MAO solution (30% w in toluene) diluited with 1.5 ml of toluene to scavenge impurities and residual water.

The catalytic complex was prepared by adding 42 mg of metallocene (A-4) in 4.1 ml of MAO solution (30% w/w in toluene).

The so obtained catalytic mixture is impregnated on support A (treated as described above) according to procedure described in WO 01/44319.

The obtained supported catalytic system contains 9.5% w of Aluminium and 910 ppm of Zirconium measured via Ion Coupled Plasma.

Catalyst C-2

3.7 g of support B described above, were treated with H₂O dispersed in hexane in order to deactivate the MgCl₂/Ti-based catalyst, then dried in a flow of nitrogen. The support is contacted with 0.4 mL of MAO solution (30% w in toluene) diluited with 1.6 ml of toluene to scavenge impurities and residual water.

The catalytic complex was prepared by adding 41 mg of metallocene (A-3) in 4.3 ml of MAO solution (30% w/w in toluene).

The so obtained catalytic mixture is impregnated on support B (treated as described above) according to procedure described in WO 01/44319.

The obtained supported catalytic system contains 13.4% w of Aluminium and 1030 ppm of Zirconium measured via Ion Coupled Plasma.

Catalyst C-3

5.6 g of support A described above, were treated with H₂O dispersed in hexane in order to deactivate the MgCl₂/Ti-based catalyst, then dried in a flow of nitrogen. The support is contacted with 0.7 mL of MAO solution (30% w in toluene) diluited with 1.3 ml of toluene to scavenge impurities and residual water.

The catalytic complex was prepared by adding 66 mg of metallocenes (A-2) in 6.6 ml of MAO solution (30% w/w in toluene).

The so obtained catalytic mixture is impregnated on support A (treated as described above) according to procedure described in WO 01/44319.

The obtained supported catalytic system contains 9.9% w of Aluminium and 0.10% w of Zirconium measured via Ion Coupled Plasma.

Catalyst C-4

5.0 g of support A described above, were treated with H₂O dispersed in hexane in order to deactivate the MgCl₂/Ti-based catalyst, then dried in a flow of nitrogen. The support is contacted with 0.5 mL of MAO solution (30% w in toluene) diluited with 1.5 ml of toluene to scavenge impurities and residual water.

The catalytic complex was prepared by adding 89 mg of metallocene (A-1) in 4.5 ml of MAO solution (30% w/w in toluene).

The so obtained catalytic mixture is impregnated on support A (treated as described above) according to procedure described in WO 01/44319.

The obtained supported catalytic system contains 8.9% w of Aluminium and 0.14% w of Zirconium measured via Ion Coupled Plasma.

Catalyst C-5 (Comparative)

3 kg of silica (Sylopol 948™) is loaded in a process filter whose filter plate points upward, and suspended in 15 L of toluene. While stirring 7 L of a 30% strength by weight MAO solution are metered in at such a rate that the internal temperature does not exceed 35° C. After stirring for another 1 hour at a low stirrer speed, the process filter is turned that its filtration plate points downwards, the suspension is filtered, firstly under atmospheric pressure and then using 3 bar of nitrogen pressure. In parallel to the treatment of the support material, 2.0 L of 30% strength by weight MAO solution and 92.3 g of rac-dimethylsilylbis(2-methyl-4-(para-tert-butylphenyl)-indenyl)-zirconium dichloride are placed in a reaction vessel, the solution is stirred for 1 hour and allowed to settle for a further 30 minutes. The solution is subsequently added to the pretreated support material with the outlet closed. After addition is complete, the outlet is opened and the filtrate is allowed to drain. When no more runs off, the outlet is closed, the filter cake is stirred for 15 minutes and allowed to rest for 1 hour. A nitrogen pressure of 3 bar is subsequently applied with the outlet open. 15 L of isododecane are added to the remaining solid, the mixture is stirred for 15 minutes and filtered. The washing step is repeated, and the solid is subsequently pressed dry by means of a nitrogen pressure of 3 bar. For use in the polymerization, the total amount of the catalyst is resuspended in 15 L of isododecane.

The catalyst system contains 0.16% w of Zirconium.

Catalyst C-6 (Comparative)

7.39 g of silica (XPO2107 from Grace) was dried at 180° C. for 17 hours at a pressure of 15 mbar. Metallocene compound A-1 (24 μmol) was dissolved in toluene (5 ml) and stirred for 10 minutes, then 7.8 ml of a 30% solution of metylalumoxane in toluene (MAO from Albemarle) solution was added dropwise and color changed immediately from orange to ruby-red. the obtained suspension was stirred for 1 hour and then added dropwise to 1 g of dry silica gel purified as described above. The resulting suspension was stirred until a dark pink colour was obtained. The suspension was finally dried in vacuo for 1.5 hours at 50° C. The resulting catalyst system contains 0.16 wt % of Zr, Al/Zr=209

### Polymerization Examples 1-7

General Procedure

All polymerization tests were carried out in a 4.250 L stainless steel Reactor, operated by a Yokogawa system, and equipped with a “ribbon” helical stirrer, with stirring rate of 300-400 RPM, a stainless steel vial for catalyst injection, and a look-through glass window.

Step a)

The reactor is purified by washing with 2L hexanes containing 5-6 mL TEA (triethylaluminum) 10% (1M), stirring 1 h at 70° C., and then discharging the solution through the bottom valve under N₂ pressure. The reactor temperature is lowered to 30° C., and the reactor pressure to 0.5 bar-g. Then the scavenger (4 mL 1M TEA in hexane) is added under a stream of propylene, and 430 g of liquid propylene is added. The catalyst is added to the reactor through a stainless steel vial. For Polyethylene supported catalysts, the dry powder is loaded into the steel vial under N₂ stream, injected into the reactor by N₂ overpressure, then the vial rinsed with 3-4 mL of hexanes into the reactor, again with N₂ overpressure. For SiO₂ supported catalysts, the powder is added as a slurry in hexanes. The homopolymer is produced in liquid monomer, by first a prepolymerization at 30° C. for 5 min, then adding 100 NmL of H₂, and the temperature is raised in 10 minutes at the polymerization temperature of 70° C. and this temperature is kept constant until the pressure starts decreasing and no liquid phase is observed.

Step b)

Then the reactor is vented to 0.5 bar-g, the temperature is set at 60° C. and the comonomers are fed in the ratio indicated in table 1, until a pressure of 25 bar-g is reached. The comonomers are fed at constant temperature and pressure until 500 grams are taken in, or for a total polymerization time of two hours.

The polymerization is stopped by venting the monomers. The reactor is cooled, purged with N₂, opened to inspect fouling, and the polymer is collected and dried in a vacuum oven at 60° C. for 1 hour. Polymerization data and characterisation of the obtained polymers are reported in table 2.

TABLE 2

| | | step a) | | step b) | | | | |
|---|---|---|---|---|---|---|---|---|
| | cat. | time | yield | C₂⁻ | C₃⁻ | C₂/C₃ | time | |
| Ex | (mg) | min. | g | g | g | mol ratio | min. | kg_{COP}/g_{cat}/h |
| 1 | C-2 (307) | 40 | 149 | 34 | 135 | 0.38 | 95 | 1.0 |
| 2 | C-1 (411) | 30 | 96 | 79 | 46 | 2.58 | 117 | 0.6 |
| 3 | C-4 (440) | 13 | 128 | 34 | 135 | 0.38 | 51 | 1.3 |
| 4* | C-6 (205) | 24 | 120 | 34 | 156 | 0.33 | 71 | 2.1 |
| 5 | C-3 (328) | 20 | 210 | 34 | 135 | 0.38 | 159 | 0.6 |
| 5 | C-3 (351) | 25 | 140 | 61 | 81 | 1.13 | 126 | 0.7 |
| 7* | C-5 (170) | 40 | 190 | 61 | 81 | 1.13 | 81 | 2.2 |

| | | | | | | C_{2, copo} | mmmm |
|---|---|---|---|---|---|---|---|
| | IV_{(THN)} | split# | XS | IV_{(XS)} | XI | NMR | homopolymer |
| Ex | dl/g | % wt | % wt | dl/g | % wt | % wt | >97% |
| 1 | 1.33 | 77 | 76 | 1.5 | 24 | 25.7 | >97% |
| 2 | 2.05 | 84 | 74 | 2.4 | 26 | 55.4 | >97% |
| 3 | 1.7 | 79.6 | 74 | 1.8 | 25.9 | 24.2 | >97% |
| 4* | 1.9 | 81 | 80.7 | 2 | 19.3 | 25.8 | >97% |
| 5 | 2 | 70.4 | 66 | 2.3 | 33.7 | 23.0 | >97% |
| 7* | n.a. | 72 | n.a. | n.a. | n.a. | 47.6 | >97% |

*comparative
n.a. not available

n.a. not available

# rubber content in the composition

Flowability Test

A flowability test was designed to compare the behaviour of particles of soft and sticky materials. The degree of flowability is rated on a scale of 1 to 8. 1-2 means no clumping hence good flowability, 3 to 7 means increasing clumping hence poor flowability, 8 means a solid clump hence no flowability at all. The test procedure is the following:
Equipment: a 50 mm diameter PMMA cylinder (h 150 mm) weights to supply an even pressure on the surface of the cylinder an open-air flow vented oven.

Procedure:
1) place the cylinder on a tray
2) fill the cylinder with enough polymer to obtain a solid bed with height of 100 mm
3) vibrate the cylinder to allow particles to settle. Additional particles are added if the solid height decreases
4) place the sample in oven at 40° C. for 2 hours
5) remove sample from the oven and carefully lift the cylinder from around the particles. The particles may fall out of the cylinder or maintain the shape of the cylinder.
6) in this last case, increasing weight is added on a plate put on the top of the solid block, until the particles or clumps fall apart

behaviour is rated according to the rules reported in table 3. The results of the text carried out on samples of the polymers obtained in examples 1-7 are reported in table 4.

TABLE 3

| rate | behaviour |
|---|---|
| 1 | once lift the cylinder the particles don't stuck together |
| | and fall apart, even if some clumping are present |
| 2 | once lift the cylinder the particles stay with the shape of |
| | the cylinder but after putting a weight up to 70 g evenly |
| | distributed with a plate on the top of the solid block, the |
| | particles fall apart in a time <100 sec |
| 3 | as 2, but the breaking of the clump requires a time >100 sec |
| 4 | as 2, but to break the particles block the weight has to be |
| | increased up to 80 g and the particles fall apart in <100 sec |
| 5 | as 4, but the breking of the clump happens after a time >100 |
| | sec |
| 6 | as 4, but to break the particles block the weight has to be |
| | increased up to 100 g and the particles fall apart in <100 |
| | sec |
| 7 | as 6 but the breaking is slow and requires >100 sec. |
| 8 | the particles are completely clumped and a weight >150 g is |
| | required to break apart the clumps. |

TABLE 4

| sample | % split | % w C₂ copo | flowability |
|---|---|---|---|
| 1 | 77 | 25.7 | 2 |
| 2 | 84 | 55.4 | 1 |
| 3 | 79.6 | 24.2 | 1 |
| 4* | 81 | 25.8 | 7 |
| 5 | 70.4 | 23 | 1 |
| 7* | 72 | 47.6 | 5 |

1-17. (canceled)

18. A multistage process comprising the following steps:
polymerizing a propylene resin optionally comprising one or more monomers selected from ethylene and alpha olefins of formula CH₂═CHT¹, wherein T¹ is a C₂-C₂₀ alkyl radical in presence of a catalyst system, the catalyst system supported on a porous organic polymer, comprising:
i) at least one metallocene compound of formula (I): 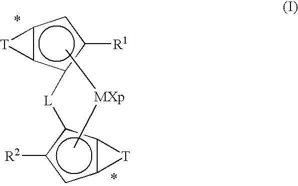
wherein M is a transition metal selected from those belonging to group 3, 4, 5, 6 or to a lanthanide or actinide group in the Periodic Table of the Elements;
p is an integer from 0 to 3, wherein p is equal to a formal oxidation state of M minus 2;
X, same or different, is hydrogen, a halogen, or R, OR, OSO₂CF₃, OCOR, SR, NR₂ or PR₂, wherein R is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical, optionally containing heteroatoms belonging to groups 13-17 of the Periodic Table of the Elements; or two X can optionally form a substituted or unsubstituted butadienyl radical or OR′O, wherein R is a divalent radical selected from C₁-C₂₀ alkylidene, C₆-C₄₀ arylidene, C₇-C₄₀ alkylarylidene and C₇-C₄₀ arylalkylidene radicals;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms;
R¹, is a linear or branched, saturated or unsaturated C₁-C₄₀-alkyl radical, optionally containing one or more heteroatoms belonging to groups 13-17 of the Periodic Table of the Elements;
R² is a branched C₁-C₄₀-alkyl radical;
T, equal to or different from each other, is a moiety of formula (IIIa) or (IIIb): 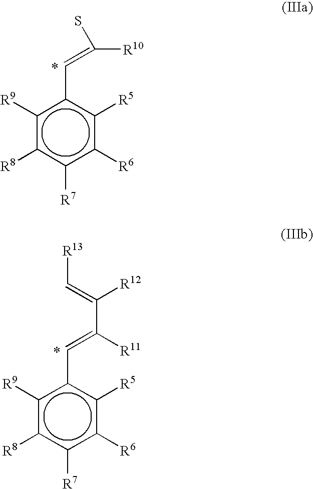
wherein:
the atom marked with symbol * is bonded to the atom marked with the same symbol in the metallocene compound of formula (I);
R⁵, R⁶, R⁷, R⁸ and R⁹, equal to or different from each other, are hydrogen or a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or two or more R⁵, R⁶, R⁷, R⁸ and R⁹ can join to form a 4-7 membered saturated or unsaturated ring, said ring can bear at least one C₁-C₂₀ alkyl substituent;
R¹⁰ is hydrogen or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radical, optionally containing one or more heteroatoms belonging to groups 13-17 of the Periodic Table of the Elements;
R¹¹, R¹² and R¹³, equal to or different from each other, are hydrogen or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two or more R¹¹, R¹² and R¹³ can join to form a 4-7 membered saturated or unsaturated ring, said ring can bear at least one C₁-C₂₀ alkyl substituent;
ii) an alumoxane or a compound capable of forming an alkyl metallocene cation;
contacting under polymerization conditions in a gas phase, ethylene with one or more alpha olefins of formula CH₂═CHT², wherein T² is a C₁-C₂₀ alkyl radical, and optionally with a non-conjugated diene, in presence of the propylene resin.

19. The multistage process according to claim 18, wherein the catalyst system further comprises iii) an organo aluminum compound.

20. The multistage process according to claim 18, wherein the process of polymerizing a propylene resin is carried out in presence of an additional organo aluminum compound.

21. The multistage process according to claim 18, wherein M is titanium, zirconium or hafnium; X is hydrogen, a halogen, or R, wherein R is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical, optionally containing heteroatoms belonging to groups 13-17 of the Periodic Table of the Elements; and L is selected from Si(Me)₂, SiPh₂, SiPhMe, SiMe(SiMe₃), CH₂, (CH₂)₂, (CH₂)₃ and C(CH₃)₂.

22. The multistage process according to claim 18, wherein R¹ is a methyl or ethyl radical; R² is a group of formula (II): 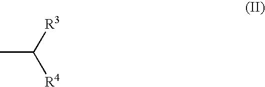
wherein R³ and R⁴, equal to or different from each other, are linear or branched, saturated or unsaturated C₁-C₁₀-alkyl radicals optionally containing one or more heteroatoms belonging to groups 13-17 of the Periodic Table of the Elements; and R¹⁰ is a hydrogen atom or a linear or branched, saturated C₁-C₂₀-alkyl radical.

23. The multistage process according to claim 18, wherein R⁵, R⁶, R⁸ and R⁹, are hydrogen, and R⁷ is a group of formula —C(R¹⁴)₃, wherein R¹⁴, equal to or different from each other, are a linear or branched, saturated or unsaturated C₁-C₁₀-alkyl, C₃-C₁₀-cycloalkyl, C₆-C₁₀-aryl, C₇-C₁₀-alkylaryl, or C₇-C₁₀-arylalkyl radicals, optionally containing one or more heteroatoms belonging to groups 13-17 of the Periodic Table of the Elements.

24. The multistage process according to claim 23, wherein T have formula (IIIb).

25. The multistage process according to claim 24, wherein one T R¹² is a C₁-C₂₀ alkyl radical, and in the other T R¹² is hydrogen.

26. The multistage process according to claim 23, wherein one T has formula (IIIa), and one T has formula (IIIb).

27. The multistage process according to claim 23, wherein T have formula (IIIb) , and R¹¹, R¹² and R¹³ are hydrogen.

28. The multistage process according to claim 23, wherein the organic porous polymer has pores having a diameter up to 10 μm (100000 Å) and a porosity higher than 0.1 cc/g.

29. The multistage process according to claim 28, wherein the organic porous polymer has pores having a diameter between 0.02 μm (200 Å) and 10 μm (100000 Å).

30. The multistage process according to claim 29, wherein at least 30% of the total porosity of the organic porous polymer is comprised of pores having a diameter between 0.1 μm (1000 Å) and 2 μm (20000 Å).

31. The multistage process according to claim 18, wherein the propylene resin comprises from 5% to 90% by weight of a propylene homopolymer or a propylene copolymer comprising up to 20% by mol of one or more alpha olefins of formula CH₂═CHT¹, wherein T¹ is a C₂-C₂₀ alkyl radical, and from 10 to 95% by weight, of an ethylene copolymer comprising from 5% to 90% by mol of one or more alpha olefins of formula CH₂═CHT², wherein T² is a C₁-C₂₀ alkyl radical.

32. The multistage process according to claim 31, wherein the ethylene copolymer comprises up to 20% by mol of a non conjugated diene.

33. The multistage process according to claim 31, wherein the propylene resin is a propylene homopolymer.

34. The multistage process according to claim 31, wherein the alpha olefins are selected from propylene and 1-butene.

35. A propylene polymer composition comprising:
a) 5% to 90% by weight of a propylene homopolymer or a propylene copolymer containing up to 20% by mol of derived units of one or more alpha olefins of formula CH₂═CHT¹ wherein T¹ is a C₂-C₂₀ alkyl radical; the propylene homopolymer or propylene copolymer having isotactic pentads (mmmm) higher than 90%;
b) from 10 to 95% by weight of an ethylene copolymer containing from 5% to 90% by mol of one or more alpha olefins of formula CH₂═CHT², wherein T² is a C₁-C₂₀ alkyl radical;
wherein the propylene polymer composition has a flowability index equal to or lower than 2, and the propylene polymer composition is produced by the following steps:
polymerizing a propylene resin optionally comprising one or more monomers selected from ethylene and alpha olefins of formula CH₂═CHT¹, wherein T¹ is a C₂-C₂₀ alkyl radical in presence of a catalyst system, the catalyst system supported on a porous organic polymer, comprising:
ii) at least one metallocene compound of formula (I): 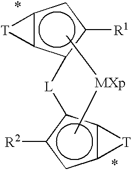
wherein M is a transition metal selected from those belonging to group 3, 4, 5, 6 or to a lanthanide or actinide group in the Periodic Table of the Elements;
p is an integer from 0 to 3, wherein p is equal to a formal oxidation state of M minus 2;
X, same or different, is hydrogen, a halogen, or R, OR, OSO₂CF₃, OCOR, SR, NR₂ or PR₂, wherein R is a linear or branched, saturated or unsaturated C₁-C₂₀ alkyl, C₃-C₂₀ cycloalkyl, C₆-C₂₀ aryl, C₇-C₂₀ alkylaryl or C₇-C₂₀ arylalkyl radical, optionally containing heteroatoms belonging to groups 13-17 of the Periodic Table of the Elements; or two X can optionally form a substituted or unsubstituted butadienyl radical or OR'O, wherein R is a divalent radical selected from C₁-C₂₀ alkylidene, C₆-C₄₀ arylidene, C₇-C₄₀ alkylarylidene and C₇-C₄₀ arylalkylidene radicals;
L is a divalent bridging group selected from C₁-C₂₀ alkylidene, C₃-C₂₀ cycloalkylidene, C₆-C₂₀ arylidene, C₇-C₂₀ alkylarylidene, or C₇-C₂₀ arylalkylidene radicals optionally containing heteroatoms belonging to groups 13-17 of the Periodic Table of the Elements, and silylidene radical containing up to 5 silicon atoms;
R¹, is a linear or branched, saturated or unsaturated C₁-C₄₀-alkyl radical, optionally containing one or more heteroatoms belonging to groups 13-17 of the Periodic Table of the Elements; R² is a branched C₁-C₄₀-alkyl radical;
T, equal to or different from each other, is a moiety of formula (IIIa) or (IIIb): 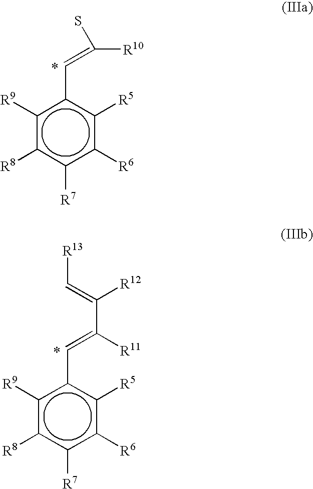
wherein:
the atom marked with symbol * is bonded to the atom marked with the same symbol in the metallocene compound of formula (I);
R⁵, R⁶, R⁷, R⁸ and R⁹, equal to or different from each other, are hydrogen or a linear or branched, saturated or unsaturated C₁-C₄₀-alkyl, C₃-C₄₀-cycloalkyl, C₆-C₄₀-aryl, C₇-C₄₀-alkylaryl, or C₇-C₄₀-arylalkyl radicals, optionally containing one or more heteroatoms belonging to groups 13-17 of the Periodic Table of the Elements; or two or more R⁵, R⁶, R⁷, R⁸ and R⁹ can join to form a 4-7 membered saturated or unsaturated ring, said ring can bear at least one C₁-C₂₀ alkyl substituent;
R¹⁰ is hydrogen or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radical, optionally containing one or more heteroatoms belonging to groups 13-17 of the Periodic Table of the Elements;
R¹¹, R¹² and R¹³, equal to or different from each other, are hydrogen or a linear or branched, saturated or unsaturated C₁-C₂₀-alkyl, C₃-C₂₀-cycloalkyl, C₆-C₂₀-aryl, C₇-C₂₀-alkylaryl, or C₇-C₂₀-arylalkyl radicals, optionally containing one or more heteroatoms belonging to groups 13-17 of the Periodic Table of the Elements; or two or more R¹¹, R¹² and R¹³ can join to form a 4-7 membered saturated or unsaturated ring, said ring can bear at least one C₁-C₂₀ alkyl substituent;
ii) an alumoxane or a compound capable of forming an alkyl metallocene cation;
contacting under polymerization conditions in a gas phase, ethylene with one or more alpha olefins of formula CH₂═CHT², wherein T is a C₁-C₂₀ alkyl radical, and optionally with a non-conjugated diene, in presence of the propylene resin.
